(19) United States
(12) Patent Application Publication
(10) Pub. No.: US 2020/0402073 A1
(43) Pub. Date: Dec. 24, 2020

(54) VERIFIABLE POST-QUANTUM ELECTRONIC VOTING SYSTEM AND IMPLEMENTATION METHOD THEREFOR

(71) Applicant: SOUTH CHINA UNIVERSITY OF TECHNOLOGY, Guangzhou, Guangdong Province (CN)

(72) Inventors: Shaohua TANG, Guangzhou (CN); Chen WU, Guangzhou (CN)

(21) Appl. No.: 16/975,699

(22) PCT Filed: Feb. 18, 2019
(86) PCT No.: PCT/CN2019/075343

§ 371 Date: Aug. 25, 2020

(30) Foreign Application Priority Data
Feb. 27, 2018 (CN) 201810161204.1

(51) Int. Cl. G06Q 30/00; G06Q 50/26; G06Q 10/10; H04L 9/32; H04L 9/30; H04L 9/00; H04L 9/06; G07C 13/00

(52) U.S. Cl. CPC G06Q 30/0185; G06Q 50/265; G06Q 10/10; H04L 9/3247; H04L 9/3073; H04L 2209/463; H04L 9/3268; H04L 9/0618; G07C 13/00; G06Q 2230/00; G06Q 2220/00; H04L 9/008

(57) ABSTRACT

A verifiable post-quantum electronic voting system and an implementation method includes an authentication center, a user end, a verification server, a vote counting server, a verification program, and a bulletin board. The authentication center verifies the identity of a user, generates an identity ID for each valid user, and signs it; the user end proves its identity to the authentication center, receives an identity ID signature, encrypts a ballot, and sends a ballot ciphertext and the identity ID signature to the verification server; and the verification server, which comprises two servers, completes the verification of the validity of the ballot and homomorphic vote counting. The vote counting server decrypts partially homomorphic vote counting ciphertext and issues it on the bulletin board, and the verification program verifies whether the vote counting server has correctly counted the ballots.

### FIELD OF THE INVENTION

The present invention relates to a field of information security technologies, and in particular, to a verifiable post-quantum electronic voting system and an implementation method thereof.

### BACKGROUND OF THE INVENTION

With the rapid development and popularization of information technology, more and more needs can be realized through the Internet, one of which is online voting. Data shows that online voting is convenient and fast, and it can improve the enthusiasm and participation of the people, and to a certain extent, it is conducive to promoting the process of democratization. In addition, online voting has the advantages of low cost, low human error rate and high ticketing efficiency. It has gradually been accepted by people. Some countries and regions are also trying to use the online voting system to conduct some elections.

While online voting has brought great convenience to people, it also faces many challenges. With the continuous improvement of people's rights awareness, how to protect users' privacy through cryptography technology, how to verify the validity of ballot content in the encrypted state, and how to ensure the correctness of the counting result are increasingly serious problems that need to be solved. On the other hand, the emergence of quantum computers has raised deep concerns about the security of traditional cryptography programs. In this context, post-quantum cryptography came into being, and cryptography based on lattice theory (lattice cryptography) is a good alternative for post-quantum cryptography. Among them, the LWE-based cryptosystem can be stipulated to the worst-case lattice problem, is provably secure, and has relatively high performance, so it has become the focus of research. The existing online voting schemes either use traditional encryption schemes such as Paillier, or they can't resist the attack of quantum computers, or they can't verify the validity of the ballots in the ciphertext state, so there are great problems in terms of security and functionality.

Therefore, there is an urgent task to construct a post-quantum electronic voting system, which can protect the user's privacy, verify the validity of ballots and the results of voting, and resist the attack of quantum computers.

### SUMMARY OF THE INVENTION

The object of the present invention is to overcome the shortcomings and deficiencies of the prior art, and to provide a verifiable post-quantum electronic voting system, which is capable of verifying the validity of ballot content on a ciphertext field, verifying the correctness of the vote counting result, accounting for malicious users attempting to manipulate the voting results through illegal ballots, while having high computational efficiency.

Another object of the present invention is to provide an implementation method of the above-described verifiable post-quantum electronic voting system.

To achieve the above objects, the present invention adopts the following technical solutions:

A verifiable post-quantum electronic voting system, comprising the authentication center, the user end, the verification server, the vote counting server, the verification program, and the bulletin board;

The authentication center is configured to verify an identity of a user, generate an identity ID for each valid user, and sign the identity ID; the authentication center comprises an identity ID generation module and a signature module, and provides a public and private key pair for signature;

The user end proves its identity to the authentication center, receives an identity ID signature, encrypts its own ballot, and sends a ballot ciphertext and the identity ID signature to the verification server; the user end comprises a ballot plaintext generation module and an encryption module; when starting a voting, a user first sends his/her own identity certificate to the authentication center, and after obtaining an authentication, obtains its own identity ID signature; then uses the encryption module to encrypt its own ballot content based on algorithms, and then sends the encrypted ballot content to the verification server along with its own identity ID signature;

The verification server comprises two servers: a verification server A and a verification server B, and the two servers interact with each other to complete the verification of a validity of the ballot and a homomorphic vote counting work; the verification server A comprises a signature verification module, a validity verification module A and a homomorphic vote counting module; the verification server B comprises a validity verification module B and a first trusted storage module for storing system's private keys;

The vote counting server is configured to decrypt the partially homomorphic vote counting ciphertext and issue the decrypted result on the bulletin board; after the voting is ended, the vote counting server will also accept the verification request of the verification program; The vote counting server comprises a decryption module, a verification response module, and a second trusted storage module for storing system's private keys;

The vote counting server is configured to decrypt partially homomorphic vote counting ciphertext and issue a decrypted result on the bulletin board; after the voting is ended, the vote counting server will also accept a verification request of the verification program; the vote counting server comprises a decryption module, a verification response module, and a second trusted storage module for storing system's private keys;

The verification program is configured to verify whether the vote counting server has correctly counted the votes, that is, correctly decrypting a result of the ciphertext of the partially homomorphic vote counting; the verification program comprises an encryption module and a homomorphic operation module;

The bulletin board is configured to issue the partially homomorphic vote counting ciphertext and partially homomorphic vote counting results.

As a preferred technical solution, the validity verification module A is used in a pre-processing stage of ballot validity verification, and the module comprises two components: a random vector generation component and a ciphertext bit accumulation component; wherein the random vector generation component is configured to generate a vector consisting of random numbers; the ciphertext bit accumulation component is configured to perform bitwise homomorphic accumulation and randomized homomorphic accumulation operations on the ballot ciphertext; after completing the pre-processing stage of the ballot ciphertext, sending processed intermediate data to the verification server B; in addition, after obtaining final verification results returned by the verification server B, the validity verification module A will pass the verified ballot to the homomorphic vote counting module, and the ballot that has not passed the verification will be discarded, and the identity ID signature corresponding to the ballot will be recorded in a blacklist; the homomorphic vote counting module is used to operate a homomorphic addition on a set of the valid ballots with a fixed number, and send results of the operation to the bulletin board for display.

As a preferred technical solution, using the LWE algorithm to process the encryption and decryption of the system;

The validity verification module B comprises a decryption component for decrypting data sent by the validity verification module A;

The homomorphic operation module of the verification program further comprises a random number generation component for generating a random number.

A method for implementing a verifiable post-quantum electronic voting system comprises the following steps:

S1. system initialization step, which is specifically as follows:
S11. select and generate public parameters;
S12. generate a public-private key pair and a system public-private key pair used for the signature according to the public parameters.
S13. the authentication center generates identity information of all valid voters;
S14. the voter obtains a system public key, the vote counting server and the verification server B share a system private key, and the verification server A obtains a signature public key;
S15. the verification server B generates a compressed system private key;
S2. voter registration step, which is specifically as follows:
S21. send identity information to the authentication center;
S22. the authentication center verifies the received user identity information, and assigns an identity ID to the authenticated user;
S23. the authentication center signs the identity ID by using the signature private key;
S24. the user receives the identity ID signature;
S3. user voting step, which is specifically as follows:
S31. the user makes his own voting selection and generates a ballot plaintext;
S32. encrypt the voting selection by using the system public key;
S33. encapsulate the ballot ciphertext and the identity ID signature into a ballot and send to the verification server A;
S4. identity verification step, which is specifically as follows:
S41. the verification server A uses the signature public key to verify the identity ID signature sent by the user;
S42. if the verification is passed, verify the validity of the ballot; and if the verification fails, directly discard the ballot;
S5. ballot validity verification step, which is specifically as follows:
S51. the verification server A invokes the random vector generation component to generate a random vector;
S52. pre-process the ballot: the verification server A invokes the ciphertext bit accumulation component to perform bitwise homomorphic accumulation and randomized homomorphic accumulation operations on the ballot ciphertext;
S53. send the preprocessed data to the verification server B;
S54. after receiving the data sent by the verification server A, the verification server B uses the data to perform a conventional decryption and randomized decryption, and judges the decryption results;
S55, return the judgment results to the verification server A;
S56. the verification server A processes the ballot according to the verification results returned by the verification server B; if the verification is passed, perform the next step of vote counting; if the verification fails, discard the ballot, and the corresponding identity ID signature is placed in the blacklist;
S6. partially homomorphic vote counting step, which is specifically as follows:
S61. according to the parameters generated by the system, the verification server A performs a homomorphic addition operation on a set of the valid ballots with a fixed number, sends the generated partially homomorphic vote counting ciphertext to the vote counting server for decryption, and simultaneously sends the same to the bulletin board for publicity;
S62. delete a single ballot that has already undergone partially homomorphic vote counting to further protect the privacy of the user;
S63. repeat step S61 and step S62 until the voting process ends;
S7, the vote counting step, which is specifically as follows:
S71. after receiving the partially homomorphic vote counting ciphertext, the vote counting server decrypts the ciphertext by using the private key in the second trusted storage module, and sends the result to the bulletin board for publicity; during decrypting, an error correction code mechanism is performed to reduce the decryption error introduced by the LWE algorithm;
S72. accumulate the results of the partially homomorphic vote counting of each group, and publish the final voting result;
S8. vote counting result verification step, which is specifically as follows:
S81. the verification program reads the partially homomorphic vote counting result from the bulletin board, encrypts the result using the system public key, and then passes the encryption result to the homomorphic operation module;
S82. the homomorphic operation module reads the partially homomorphic vote counting ciphertext published on the bulletin board, and performs a homomorphic subtraction operation on the received encryption result and the ciphertext, and sends the operation result to the vote counting server;
S83. read the decryption result returned by the vote counting server and perform a first step verification, the first step verification is to determine whether the decryption result is 0;
S84. if the first step verification is passed, perform a second step verification: invoke the random number generation component in the homomorphic operation module to generate a random number, process the random number and the result of the homomorphic subtraction operation in step S82 and send it to the vote counting server again, and read the result returned by the vote counting server and verify it;
S85. if the second step verification is passed, the preliminary determination of the vote counting result is correct;
S86. according to the security requirements of the voting, perform multiple rounds of verification for each group of votes, that is, repeatedly perform steps S81-S85;
S87. perform step S81 to step S86 for each group of the homomorphic vote counting ciphertext and the partially homomorphic vote counting result until the verification is completed for each group.

As a preferred technical solution, in the voting step S3, each sub-step is specifically:

S31. the user makes his own voting selection and generates the ballot plaintext:
in the voting system, the ballot plaintext is in the form of a 01 string of length l, and each bit in the string corresponds to a candidate; one and only one bit of the ballot strings is 1 and the remaining bits are 0; the one with a value of 1 is the candidate selected by the user, and the ballot plaintext is marked as vote;
S32. encrypt the ballot string by using the system public key, and generate the ballot ciphertext as follows:

C=(b=(Ar+x),b′=(u^{T}r+x′+f(vote)))

where f(vote) means multiplying each character in the vote by

$$\frac{q}{V H o {m}_{max}} ;$$

r, x, x′ are all matrices generated according to the Gaussian distribution in the LWE encryption process, and for convenience, the result of (Ar+x) is recorded as b, the result of (u^{T}r+x′+f(vote)) is recorded as b′;
S33. encapsulate the ballot ciphertext C and the identity ID signature into a ballot and send the ballot to the verification server A.

As a preferred technical solution, in the ballot validity verification step S5, each sub-step is specifically:

S51. the verification server A invokes a random vector generation component to generate a random vector \vec{rand};
S52. pre-process the ballot: the verification server A invokes the ciphertext bit accumulation component to perform bitwise homomorphic accumulation and randomized homomorphic accumulation operations on the ballot ciphertext;
the pre-processing is specifically to calculate:

$${b}_{sum 1} = b , {b}_{s u m 1}^{′} = {\sum }_{i = 1}^{l} {b}_{i}^{′} , {b}_{s u m 2}^{′} = {\sum }_{i = 1}^{l} {b}_{i}^{′} ran {d}_{i}$$

where bₛₘ₁, b′ₛᵤₘ₁, b′ₛₘ₂ represent the results of three operations, respectively;
S53. send bₛₘ₁, b′ₛᵤₘ₁, b′ₛᵤₘ₂, \vec{rand} to the verification server B;
S54. after receiving the data sent by the verification server A, the verification server B uses the data to perform a conventional decryption and randomized decryption, and judges the decryption results;
first, perform step 1 verification, obtain the system private key from the first trusted storage module, and decrypt (bₛₘ₁, b′ₛᵤₘ₁):

dec₁=b′ₛᵤₘ₁−\vec{Sₛᵤₘ^{T}}bₛᵤₘ₁

after decryption, it is judged whether the value of dec₁ is 1; if the value of dec is 1, perform the next step of verification, otherwise the verification of step 1 fails;
the second step of the verification process is as follows, calculate:

\vec{partialDecVec}=s^{T}\vec{b}º\vec{rand}

where the º operation represents multiplying every bit of the result of s^{t}b and corresponding bits in \vec{rand};
after that accumulate each bit in \vec{partialDecVec}:

$$partialDec = {\sum }_{i = 1}^{l} \vec{part ι a {lDecVec}_{i}}$$

and calculate:

dec₂=f⁻¹(b′ₛᵤₘ₂−partialDec)

if the value of dec₂ and one of the elements in \vec{rand} are equal, then the content of the ballot is finally determined to be valid;
S55. the verification server B returns the judgment result to the verification server A;
S56. the verification server A processes the ballot according to the verification results returned by the verification server B; if the verification is passed, perform the next step of vote counting; if the verification fails, discard the ballot, and the corresponding identity ID signature is placed in the blacklist.

As a preferred technical solution, in the partially homomorphic vote counting step S6, each sub-step is specifically:

S61. the verification server A performs homomorphic addition on the VHomₘₐₓ valid ballots according to the public parameters generated by the system, and generates:

PartialHomCᵢ=HomAdd(VHomₘₐₓ valid ballots)

where HomAdd indicates that adding two ciphertexts by bit;
then send the generated partially homomorphic vote counting ciphertext PartialHomCᵢ to the vote counting server for decryption, and simultaneously send to the bulletin board for publicity;
S62. delete a single ballot that has already undergone partially homomorphic vote counting to further protect the privacy of the user;
S63. repeat step S61 and step S62 until the voting process ends.

As a preferred technical solution, in the voting step S7, each sub-step is specifically:

S71. after receiving the partially homomorphic vote counting ciphertext PartialHomCᵢ, the vote counting server decrypts the ciphertext by using the private key in the second trusted storage module, and sends the generated result PartialResᵢ to the bulletin board for publicity;
S72. accumulate the results of the partially homomorphic vote counting of each group, and publish the final voting result:

Res=Σᵢ PartialResᵢ.

As a preferred technical solution, in the voting step S8, each sub-step is specifically:

S81. the verification program reads the partially homomorphic vote counting result PartialResᵢ from the bulletin board, encrypts the result using the system public key,

PartialResCᵢ=(b=(Ar+x),b′=(u^{T}r+x′+f(PartialResᵢ))),

and then passes the encryption result to the homomorphic operation module;
S82. the homomorphic operation module reads the partially homomorphic vote counting ciphertext PartialHomCᵢ published on the bulletin board, and performs a homomorphic subtraction operation on the received encryption result and the ciphertext:

PartialSubCᵢ=PartialHomCᵢ−PartialResCᵢ

and sends the operation result to the vote counting server;
S83. read the result returned by the vote counting server and perform the first step verification: determining whether the decryption result is 0; if it is 0, the first step verification is passed; if not, the first step verification fails, and determine that the result given by the vote counting server is wrong, then re-vote or report to a voting organizer;
S84. if the first step verification is passed, perform a second step verification: invoke the random number generation component in the homomorphic operation module to generate the random number, and process the random number and the result PartialSubCᵢ of the homomorphic subtraction operation in step S82:

rand₁=random(seed)

rand₂=random(seed)

testC₀=PartialSubCᵢ+LWEEnc(rand₁,PK_{lwe})

testC₁=LWEEnc(rand₂,PK_{lwe})

where PK_{lwe} represents the system public key, PK_{lwe}=(A,u^{T});
then randomly generate a bit coin ∈{0,1}, and send testC_{coin} to the vote counting server, requesting it to decrypt; to reduce the chance, repeat the second step verification three or four times;
S85. read and verify the decryption result returned by the vote counting server; if the returned result is equal to testC_{coin}, the second step verification is passed, and the preliminary determination of the vote counting result is correct;
S86. according to the security requirements of the voting, perform multiple rounds of verification for each group of votes, that is, repeatedly perform steps S81-S85;
S87. perform step S81˜S86 for each group of the partially homomorphic vote counting ciphertext PartialHomCᵢ and the partially homomorphic vote counting result PartialResᵢ until the verification is completed for each group.

The present invention has the following advantages and effects over the prior art:

1. The system of the present invention and its implementation method adopts the LWE homomorphic algorithm to perform homomorphic ticketing for all users' votes, and does not decrypt a single ballot, so no one in the system can know the specific content of a particular ballot except the user itself, which is a good guarantee for the privacy of the user, and the privacy of the user is also the most concerned issue in the electronic voting system.
2. The system of the present invention and the implementation method thereof can determine whether the ballot voted by the user is valid without decrypting the ballot ciphertext. This further protects the user's privacy while also enabling the accountability of malicious users.
3. The LWE algorithm on which the system of the present invention and its implementation method are based is capable of resisting the attack of quantum computers and is highly efficient.
4. The system of the present invention and its implementation method can verify the vote counting result for anyone, in order to deal with the hacking or virus attack on the vote counting server and prevent them from making malicious changes to the vote counting result.

### DESCRIPTION OF FIGURES

FIG. 1 is a schematic diagram showing the structure and flow of a verifiable post-quantum electronic voting system disclosed in the present invention.

FIG. 2 is a schematic diagram of a verifiable post-quantum electronic voting method disclosed in the present invention.

### DETAILED DESCRIPTION OF THE PREFERRED EMBODIMENTS

The present invention will be further described in detail below with reference to the accompanying figures and specific embodiments.

### Embodiments 1

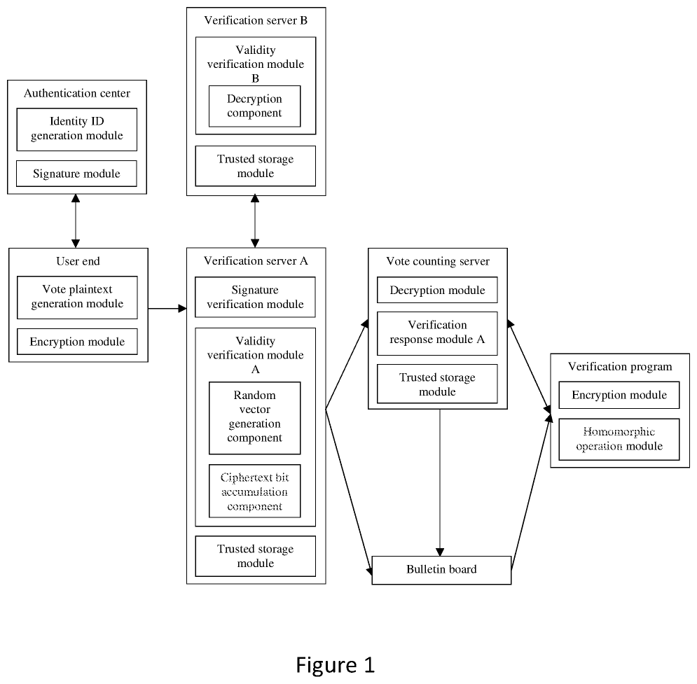

As shown in FIG. 1, the verifiable post-quantum electronic voting system comprises the authentication center, the user end, the verification server, the vote counting server, the verification program, and the bulletin board;

the authentication center is configured to verify the identity of the user, generate an identity ID for each valid user, and sign the identity ID; the authentication center comprises an identity ID generation module and a signature module, and provides a public and private key pair for signature;
the user end proves its identity to the authentication center, receives an identity ID signature, encrypts its own ballot, and sends a ballot ciphertext and the identity ID signature to the verification server; the user end comprises a ballot plaintext generation module and an encryption module; when starting voting, the user first sends his own identity certificate to the authentication center, and obtains its own identity ID signature after passing the authentication; then uses the encryption module to encrypt its own ballot content based on algorithms, and then sends the encrypted ballot content to the verification server along with its own identity ID signature;
the verification server comprises two servers: a verification server A and a verification server B, and the two servers interact with each other to complete the verification of the validity of the ballot and the homomorphic vote counting work; the verification server A comprises a signature verification module, a validity verification module A and a homomorphic vote counting module; the verification server B comprises a validity verification module B and a first trusted storage module for storing system's private keys;
the vote counting server is configured to decrypt the partially homomorphic vote counting ciphertext and issue the decrypted result on the bulletin board; after the voting is ended, the vote counting server will also accept the verification request of the verification program; The vote counting server comprises a decryption module, a verification response module, and a second trusted storage module for storing system's private keys;
the vote counting server is configured to decrypt the partially homomorphic vote counting ciphertext and issue the decrypted result on the bulletin board; after the voting is ended, the vote counting server will also accept the verification request of the verification program; The vote counting server comprises a decryption module, a verification response module, and a second trusted storage module for storing system's private keys;
the verification program is configured to verify whether the vote counting server has correctly counted the votes, that is, correctly decrypting the ciphertext result of the partially homomorphic vote counting; the verification program comprises an encryption module and a homomorphic operation module;
the bulletin board is configured to issue partially homomorphic vote counting ciphertexts and partially homomorphic vote counting results.

In this embodiment, the validity verification module A is used in a pre-processing stage of ballot validity verification, and the module comprises two components: a random vector generation component and a ciphertext bit accumulation component; wherein the random vector generation component is configured to generate a vector consisting of random numbers; the ciphertext bit accumulation component is configured to perform bitwise homomorphic accumulation and randomized homomorphic accumulation operations on the ballot ciphertext; after completing the pre-processing stage of the ballot ciphertext, sending the processed intermediate data to the verification server B; in addition, after obtaining final verification results returned by the verification server B, the validity verification module A will pass the verified ballot to the homomorphic vote counting module, and the ballot that has not passed the verification will be discarded, and the identity ID signature corresponding to the ballot will be recorded in a blacklist;

the homomorphic vote counting module is used to operate a homomorphic addition on a set of the valid ballots with a fixed number and send results of the operation to the bulletin board for display.

In this embodiment, using the LWE algorithm to process the encryption and decryption of the system. Of course, other algorithms that can achieve the same technical performance of the present invention can be applied to the present invention and are within the scope of protection of the present invention.

The validity verification module B comprises a decryption component for decrypting data sent by the validity verification module A, and can also use an error correction code to reduce errors generated during the decryption process;

The homomorphic operation module of the verification program further comprises the random number generation component for generating the random number;

In this embodiment, the ballot plaintext generation module generates a ballot plaintext string according to the user's will, for subsequent encryption;

The verification server A and the verification server B are two different physical machines, and respectively store different data;

The bulletin board is a read-only display screen;

The identity certificate of the voter may use the identity card for official elections such as the government; and for ordinary civil elections, certificate such as student ID cards and all-purpose card can be used.

### Embodiments 2

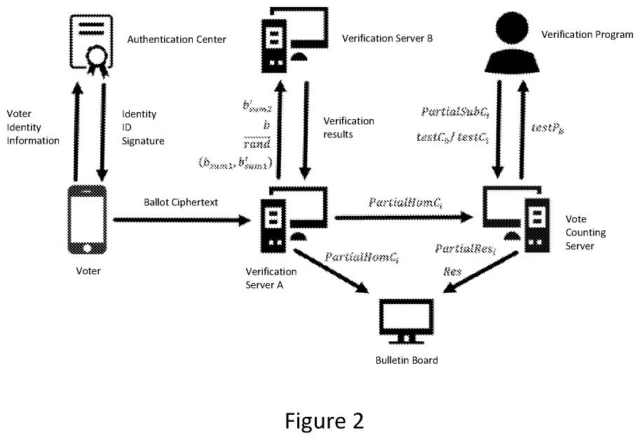

A method for implementing a verifiable post-quantum electronic voting system, such as the voting process shown in FIG. 2, comprises the following steps:

S1. System initialization step, which is specifically as follows:
S11. select and generate common parameters: select LWE encryption system parameters n,l,q,α, and homomorphic vote counting upper limit VHomₘₐₓ, where n is a security parameter of the LWE encryption system; l is the length of the ballot plaintext string, representing the number of candidates; q represents a modulus, since the homomorphic operation is an operation in a finite field, which performs the modulo q operation on calculated results; a is a parameter used in Gaussian sampling, which is related to the squared difference of samples; VHomₘₐₓ represents the maximum number of times the VSA can perform homomorphic addition for each partially homomorphic vote counting;
S12. generate the public-private key pair for the signature and the system public-private key pair according to the public parameters; the system public key is (A, u^{T}), the system private key is s; the signature public key is PK_{sig}, and the signature private key is SK_{sig}; where A is a randomly generated matrix of size n*n over a finite field of modulus q; u^{T}=s^{T}A+e^{T}, where e^{T} is a matrix of size n*l generated from Gaussian samples;
S13. the authentication center generates identity information of all valid voters, comprising the identity of the valid voter and the corresponding user identity ID;
S14. the voter obtains the system public key through reliable channels, and the vote counting server and the verification server B share the system private key through the reliable channels, and the verification server A obtains the signature public key through the reliable channels; the authentication center generates both the signature public key and the signature private key;
for the system public key and the signature public key, the reliable channels comprise the voting official website or a certificate issuing authority; for the system private key, the reliable channel is an offline exchange, the system private key is stored in a flash memory disk, and a special person is responsible for handing over the flash memory disk with the system private key to administrators of the vote counting server and the verification server B;
S15. the verification server B generates a compressed system private key:

$$\vec{{s}_{s u m}^{T}} = {\sum }_{i = 1}^{l} \vec{{s}_{ι}^{T}} = [ {\sum }_{i = 1}^{l} {s}_{i , 1}^{T} … {\sum }_{i = 1}^{l} {s}_{i , n}^{T} ]$$

where i represents the ith row of a matrix s^{T}, n represents the nth column, and T represents the transpose of a matrix.
S2. voter registration step, which is specifically as follows:
S21. send identity information to the authentication center;
S22. the authentication center verifies the received user identity information, and assigns an identity ID to the authenticated user;
S23. the authentication center signs the identity ID by using the signature private key;
S24. the user receives the identity ID signature;
S3. user voting step, which is specifically as follows:
S31. the user makes his own voting selection and generates a ballot plaintext;
S32. encrypt the voting selection by using the system public key;
S33. encapsulate the ballot ciphertext and the identity ID signature into a ballot and send to the verification server A;
S4. identity verification step, which is specifically as follows:
S41. the verification server A uses the signature public key to verify the identity ID signature sent by the user;
S42. if the verification is passed, verify the validity of the ballot; and if the verification fails, directly discard the ballot;
S5. ballot validity verification step, which is specifically as follows:
S51. the verification server A invokes the random vector generation component to generate a random vector;
S52. pre-process the ballot: the verification server A invokes the ciphertext bit accumulation component to perform bitwise homomorphic accumulation and randomized homomorphic accumulation operations on the ballot ciphertext;
S53. send the preprocessed data to the verification server B;
S54. after receiving the data sent by the verification server A, the verification server B uses the data to perform a conventional decryption and randomized decryption, and judges the decryption results;
S55, return the judgment results to the verification server A;
S56. the verification server A processes the ballot according to the verification results returned by the verification server B; if the verification is passed, perform the next step of vote counting; if the verification fails, discard the ballot, and the corresponding identity ID signature is placed in the blacklist;
S6. partially homomorphic vote counting step, which is specifically as follows:
S61. according to the parameters generated by the system, the verification server A performs a homomorphic addition operation on a set of the valid ballots with a fixed number, sends the generated partially homomorphic vote counting ciphertext to the vote counting server for decryption, and simultaneously sends the same to the bulletin board for publicity;
S62. delete a single ballot that has already undergone partially homomorphic vote counting to further protect the privacy of the user;
S63. repeat step S61 and step S62 until the voting process ends;
S7, the vote counting step, which is specifically as follows:
S71. after receiving the partially homomorphic vote counting ciphertext, the vote counting server decrypts the ciphertext by using the private key in the second trusted storage module, and sends the result to the bulletin board for publicity; during decrypting, an error correction code mechanism is performed to reduce the decryption error introduced by the LWE algorithm;
S72. accumulate the results of the partially homomorphic vote counting of each group, and publish the final voting result;
S8. vote counting result verification step, which is specifically as follows:
S81. the verification program reads the partially homomorphic vote counting result from the bulletin board, encrypts the result using the system public key, and then passes the encryption result to the homomorphic operation module;
S82. the homomorphic operation module reads the partially homomorphic vote counting ciphertext published on the bulletin board, and performs a homomorphic subtraction operation on the received encryption result and the ciphertext, and sends the operation result to the vote counting server;
S83. read the decryption result returned by the vote counting server and perform a first step verification, the first step verification is to determine whether the decryption result is 0;
S84. if the first step verification is passed, perform a second step verification: invoke the random number generation component in the homomorphic operation module to generate a random number, process the random number and the result of the homomorphic subtraction operation in step S82 and send it to the vote counting server again, and read the result returned by the vote counting server and verify it;
S85. if the second step verification is passed, the preliminary determination of the vote counting result is correct;
S86. according to the security requirements of the voting, perform multiple rounds of verification for each group of votes, that is, repeatedly perform steps S81-S85;
S87. perform step S81 to step S86 for each group of the homomorphic vote counting ciphertext and the partially homomorphic vote counting result until the verification is completed for each group.

The above-mentioned embodiments merely express several implementation methods of the present invention, and the description thereof is more specific and detailed, but it is not to be construed as limiting the scope of patent of the present invention. It should be noted that it will be apparent to those skilled in the art that variations and improvements can be made without departing from the inventive conception, which are all within the scope of protection of the present invention. Therefore, the scope of protection of the invention patent should be determined by the claims.

1. A verifiable post-quantum electronic voting system, characterized in that the system comprises an authentication center, a user end, a verification server, a vote counting server, a verification program, and a bulletin board;
wherein the authentication center is configured to verify an identity of a user, generate an identity ID for each valid user, and sign the identity ID, and wherein the authentication center comprises an identity ID generation module and a signature module and provides a public and private key pair for signature;
wherein the user end is configured to prove its identity to the authentication center, and wherein the authentication center is configured to receive an identity ID signature from the user end, encrypt a ballot, and sends a ballot ciphertext and the identity ID signature to the verification server;
wherein the user end comprises a ballot plaintext generation module and an encryption module and is configured to send an identity certificate to the authentication center and obtain the identity ID signature after passing an authentication, and wherein the encryption module is configured to encrypt ballot content based on algorithms and then send the encrypted ballot content to the verification server along with the identity ID signature;
wherein the verification server comprises two servers, a verification server A and a verification server B, and the two servers interact to complete a verification of the validity of the ballot and a homomorphic vote counting operation, wherein the verification server A comprises a signature verification module, a validity verification module A and a homomorphic vote counting module, and wherein the verification server B comprises a validity verification module B and a first trusted storage module for storing private keys;
wherein the vote counting server is configured to decrypt partially homomorphic vote counting ciphertext and issue a decrypted result on the bulletin board, wherein the vote counting server is configured to accept a verification request of the verification program after the voting is ended, and wherein the vote counting server comprises a decryption module, a verification response module, and a second trusted storage module for storing private keys;
wherein the verification program is configured to verify whether the vote counting server has correctly counted the votes by correctly decrypting a result of the ciphertext of the partially homomorphic vote counting, and wherein the verification program comprises an encryption module and a homomorphic operation module; and
wherein the bulletin board is configured to issue the partially homomorphic vote counting ciphertext and partially homomorphic vote counting results.

2. The verifiable post-quantum electronic voting system according to claim 1, characterized in that the validity verification module A is used in a pre-processing stage of ballot validity verification, and the module comprises a random vector generation component and a ciphertext bit accumulation component; wherein the random vector generation component is configured to generate a vector consisting of random numbers; wherein the ciphertext bit accumulation component is configured to perform bitwise homomorphic accumulation and randomized homomorphic accumulation operations on the ballot ciphertext and after completing the pre-processing stage of the ballot ciphertext, sending processed intermediate data to the verification server B; wherein the validity verification module A is configure to pass the verified ballot to the homomorphic vote counting module after obtaining final verification results returned by the verification server B, and wherein a ballot that has not passed the verification will be discarded and the identity ID signature corresponding to the ballot will be recorded in a blacklist; and wherein the homomorphic vote counting module operates a homomorphic addition on a set of the valid ballots with a fixed number and sends results of the operation to the bulletin board for display.

3. The verifiable post-quantum electronic voting system according to claim 1, characterized in that the system uses an LWE algorithm to process the encryption and decryption of the system;
the validity verification module B comprises a decryption component for decrypting data sent by the validity verification module A; and
the homomorphic operation module of the verification program further comprises a random number generation component for generating random numbers.

4. A voting method of the verifiable post-quantum electronic voting system according to claim 1, comprising the steps of:
S1. system initialization step, which is specifically as follows:
S11. select and generate public parameters;
S12. generate a public-private key pair used for the signature and a system public-private key pair according to the public parameters;
S13. the authentication center generates identity information of all valid voters;
S14. the voter obtains a system public key, the vote counting server and the verification server B share a system private key, and the verification server A obtains a signature public key;
S15. the verification server B generates a compressed system private key;
S2. voter registration step, which is specifically as follows:
S21. send identity information to the authentication center;
S22. the authentication center verifies the received user identity information, and assigns an identity ID to the authenticated user;
S23. the authentication center signs the identity ID by using the signature private key;
S24. the user receives the identity ID signature;
S3. user voting step, which is specifically as follows:
S31. the user makes his own voting selection and generates a ballot plaintext;
S32. encrypt the voting selection by using the system public key;
S33. encapsulate the ballot ciphertext and the identity ID signature into a ballot and send to the verification server A;
S4. identity verification step, which is specifically as follows:
S41. the verification server A uses the signature public key to verify the identity ID signature sent by the user;
S42. if the verification is passed, verify the validity of the ballot; and if the verification fails, directly discard the ballot;
S5. ballot validity verification step, which is specifically as follows:
S51. the verification server A invokes the random vector generation component to generate a random vector;
S52. pre-process the ballot: the verification server A invokes the ciphertext bit accumulation component to perform bitwise homomorphic accumulation and randomized homomorphic accumulation operations on the ballot ciphertext;
S53. send the preprocessed data to the verification server B;
S54. after receiving the data sent by the verification server A, the verification server B uses the data to perform a conventional decryption and randomized decryption, and judges the decryption results;
S55. return the judgment results to the verification server A;
S56. the verification server A processes the ballot according to the verification results returned by the verification server B; if the verification is passed, perform the next step of vote counting; if the verification fails, discard the ballot, and the corresponding identity ID signature is placed in the blacklist;
S6. partially homomorphic vote counting step, which is specifically as follows:
S61. according to the parameters generated by the system, the verification server A performs a homomorphic addition operation on a set of the valid ballots with a fixed number, sends the generated partially homomorphic vote counting ciphertext to the vote counting server for decryption, and simultaneously sends the same to the bulletin board for publicity;
S62. delete a single ballot that has already undergone partially homomorphic vote counting to further protect the privacy of the user;
S63. repeat step S61 and step S62 until the voting process ends;
S7, the vote counting step, which is specifically as follows:
S71. after receiving the partially homomorphic vote counting ciphertext, the vote counting server decrypts the ciphertext by using the private key in the second trusted storage module, and sends the result to the bulletin board for publicity; during decrypting, an error correction code mechanism is performed to reduce the decryption error introduced by the LWE algorithm;
S72. accumulate the results of the partially homomorphic vote counting of each group, and publish the final voting result; and
S8. vote counting result verification step, which is specifically as follows:
S81. the verification program reads the partially homomorphic vote counting result from the bulletin board, encrypts the result using the system public key, and then passes the encryption result to the homomorphic operation module;
S82. the homomorphic operation module reads the partially homomorphic vote counting ciphertext published on the bulletin board, and performs a homomorphic subtraction operation on the received encryption result and the ciphertext, and sends the operation result to the vote counting server,
S83. read the decryption result returned by the vote counting server and perform a first step verification, the first step verification is to determine whether the decryption result is 0;
S84. if the first step verification is passed, perform a second step verification: invoke the random number generation component in the homomorphic operation module to generate a random number, process the random number and the result of the homomorphic subtraction operation in step S82 and send it to the vote counting server again, and read the result returned by the vote counting server and verify it;
S85. if the second step verification is passed, the preliminary determination of the vote counting result is correct;
S86. according to the security requirements of the voting, perform multiple rounds of verification for each group of votes, that is, repeatedly perform steps S81-S85; and
S87. perform step S81 to step S86 for each group of the homomorphic vote counting ciphertext and the partially homomorphic vote counting result until the verification is completed for each group.

5. The method for implementing the verifiable post-quantum electronic voting system according to claim 4, characterized in that in the system initializing step S1, each sub-step is specifically:
S11. select and generate common parameters: select LWE encryption system parameters n,l,q,α, and homomorphic vote counting upper limit VHomₘₐₓ, where n is a security parameter of the LWE encryption system: l is the length of the ballot plaintext string, representing the number of candidates; q represents a modulus, since the homomorphic operation is an operation in a finite field, which performs the modulo q operation on calculated results; a is a parameter used in Gaussian sampling, which is related to the squared difference of samples; VHomₘₐₓ represents the maximum number of times the VSA can perform homomorphic addition for each partially homomorphic vote counting;
S12. generate the public-private key pair for the signature and the system public-private key pair according to the public parameters; the system public key is (A,u^{T}), the system private key is s; the signature public key is PK_{sig}, and the signature private key is SK_{sig}; where A is a randomly generated matrix of size n*n over a finite field of modulus q; u^{T}=s^{T}A+e^{T}, where e^{T} is a matrix of size n*l generated from Gaussian samples;
S13. the authentication center generates identity information of all valid voters, comprising the identity of the valid voter and the corresponding user identity ID;
S14. the voter obtains the system public key through reliable channels, and the vote counting server and the verification server B share the system private key through the reliable channels, and the verification server A obtains the signature public key through the reliable channels; the authentication center generates both the signature public key and the signature private key;
for the system public key and the signature public key, the reliable channels comprise the voting official website or a certificate issuing authority; for the system private key, the reliable channel is an offline exchange, the system private key is stored in a flash memory disk, and a special person is responsible for handing over the flash memory disk with the system private key to administrators of the vote counting server and the verification server B;
S15. the verification server B generates a compressed system private key:
$$\vec{{s}_{s u m}^{T}} = {\sum }_{i = 1}^{l} \vec{{s}_{ι}^{T}} = [ {\sum }_{i = 1}^{l} {s}_{i , 1}^{T} … {\sum }_{i = 1}^{l} {s}_{i , n}^{T} ]$$
where i represents the ith row of a matrix s^{T}, n represents the nth column, and T represents the transpose of a matrix.

6. The method for implementing the verifiable post-quantum electronic voting system according to claim 4, characterized in that in the voting step S3, each sub-step is specifically:
S31. the user makes his own voting selection and generates the ballot plaintext:
in the voting system, the ballot plaintext is in the form of a 01 string of length l, and each bit in the string corresponds to a candidate; one and only one bit of the ballot strings is 1 and the remaining bits are 0; the one with a value of 1 is the candidate selected by the user, and the ballot plaintext is marked as vote:
S32. encrypt the ballot string by using the system public key, and generate the ballot ciphertext as follows:
C=(b=(Ar+x),b′=(u^{T}r+x′+f(vote))
where f(vote) means multiplying each character in the vote by
$$\frac{q}{V H o {m}_{max}} ;$$
r,x,x′ are all matrices generated according to the Gaussian distribution in the LWE encryption process, and for convenience, the result of (Ar+x) is recorded as b, the result of (u^{T}r+x′+f(vote)) is recorded as b′;
S33. encapsulate the ballot ciphertext C and the identity ID signature into a ballot and send the ballot to the verification server A.

7. The method for implementing the verifiable post-quantum electronic voting system according to claim 4, characterized in that in the ballot validity verification step S5, each sub-step is specifically:
S51. the verification server A invokes a random vector generation component to generate a random vector \vec{rand};
S52. pre-process the ballot: the verification server A invokes the ciphertext bit accumulation component to perform bitwise homomorphic accumulation and randomized homomorphic accumulation operations on the ballot ciphertext;
the pre-processing is specifically to calculate:
$${b}_{sum 1} = b , {b}_{s u m 1}^{′} = {\sum }_{i = 1}^{l} {b}_{i}^{′} , {b}_{s u m 2}^{′} = {\sum }_{i = 1}^{l} {b}_{i}^{′} ran {d}_{i}$$
where bₛᵤₘ₁,b′ₛᵤₘ₁, b′ₛᵤₘ₂ represent the results of three operations, respectively;
S53. send bₛᵤₘ₁, b′ₛᵤₘ₁, b′ₛᵤₘ₂, \vec{rand} to the verification server B;
S54. after receiving the data sent by the verification server A, the verification server B uses the data to perform a conventional decryption and randomized decryption, and judges the decryption results;
first, perform step 1 verification, obtain the system private key from the first trusted storage module, and decrypt (bₛᵤₘ₁,b′ₛᵤₘ₁):
dec₁=b′ₛᵤₘ₁−\vec{sₛᵤₘ^{T}}bₛᵤₘ₁
after decryption, it is judged whether the value of dec₁ is 1; if the value of dec₁ is 1, perform the next step of verification, otherwise the verification of step 1 fails;
the second step of the verification process is as follows, calculate:
\vec{partialDecVec}=s^{T}\vec{b}º\vec{rand}
where the º operation represents multiplying every bit of the result of s^{t}b and corresponding bits in \vec{rand};
after that accumulate each bit in \vec{partialDecVec}:
$$partialDec = {\sum }_{i = 1}^{l} \vec{part ι a {lDecVec}_{i}}$$
and calculate:
dec₂=f⁻¹(b′ₛᵤₘ₂−partialDec)
if the value of dec₂ and one of the elements in \vec{rand} are equal, then the content of the ballot is finally determined to be valid;
S55. the verification server B returns the judgment result to the verification server A;
S56. the verification server A processes the ballot according to the verification results returned by the verification server B: if the verification is passed, perform the next step of vote counting; if the verification fails, discard the ballot, and the corresponding identity ID signature is placed in the blacklist.

8. The method for implementing the verifiable post-quantum electronic voting system according to claim 4, characterized in that in the partially homomorphic vote counting step S6, each sub-step is specifically:
S61. the verification server A performs homomorphic addition on the VHomₘₐₓ valid ballots according to the public parameters generated by the system, and generates:
PartialHomCᵢ=HomAdd(VHomₘₐₓ valid ballots)
where HomAdd indicates that adding two ciphertexts by bit;
then send the generated partially homomorphic vote counting ciphertext PartialHomCᵢ to the vote counting server for decryption, and simultaneously send to the bulletin board for publicity;
S62. delete a single ballot that has already undergone partially homomorphic vote counting to further protect the privacy of the user;
S63. repeat step S61 and step S62 until the voting process ends.

9. The method for implementing the verifiable post-quantum electronic voting system according to claim 4, characterized in that in the partially homomorphic vote counting step S7, each sub-step is specifically:
S71. after receiving the partially homomorphic vote counting ciphertext PartialHomCᵢ, the vote counting server decrypts the ciphertext by using the private key in the second trusted storage module, and sends the generated result PartialResᵢ to the bulletin board for publicity;
S72. accumulate the results of the partially homomorphic vote counting of each group, and publish the final voting result:
Res=Σᵢ PartialResᵢ.

10. The method for implementing the verifiable post-quantum electronic voting system according to claim 4, characterized in that in the partially homomorphic vote counting step S8, each sub-step is specifically:
S81. the verification program reads the partially homomorphic vote counting result PartialResᵢ from the bulletin board, encrypts the result using the system public key,
PartialResCᵢ=(b=(Ar+x),b′=(u^{T}r+x′+f(PartialResᵢ))),
and then passes the encryption result to the homomorphic operation module;
S82. the homomorphic operation module reads the partially homomorphic vote counting ciphertext PartialHomCᵢ published on the bulletin board, and performs a homomorphic subtraction operation on the received encryption result and the ciphertext:
PartialSubCᵢ=PartialHomCᵢ−PartialResCᵢ
and sends the operation result to the vote counting server:
S83. read the result returned by the vote counting server and perform the first step verification: determining whether the decryption result is 0; if it is 0, the first step verification is passed; if not, the first step verification fails, and determine that the result given by the vote counting server is wrong, then re-vote or report to a voting organizer;
S84. if the first step verification is passed, perform a second step verification: invoke the random number generation component in the homomorphic operation module to generate the random number, and process the random number and the result PartialSubCᵢ of the homomorphic subtraction operation in step S82:
rand₁=random(seed)
rand₂=random(seed)
testC₀=PartialSubCᵢ+LWEEnc(rand₁,PK_{lwe})
testC₁=LWEEnc(rand₂,PK_{lwe})
where PK_{lwe} represents the system public key, PK_{lwe}=(A,u^{T});
then randomly generate a bit coin ∈{0,1}, and send testC_{coin} to the vote counting server, requesting it to decrypt; to reduce the chance, repeat the second step verification three or four times;
S85. read and verify the decryption result returned by the vote counting server; if the returned result is equal to testC_{coin}, the second step verification is passed, and the preliminary determination of the vote counting result is correct;
S86. according to the security requirements of the voting, perform multiple rounds of verification for each group of votes, that is, repeatedly perform steps S81-S85;
S87. perform step S81˜S86 for each group of the partially homomorphic vote counting ciphertext PartialHomCᵢ and the partially homomorphic vote counting result PartialResᵢ until the verification is completed for each group.
